(19) United States
(12) Patent Application Publication
(10) Pub. No.: US 2014/0247712 A1
(43) Pub. Date: Sep. 4, 2014

(54) METHOD OF PERFORMING SHARED MESH PROTECTION SWITCHING

(71) Applicant: Electronics and Telecommunications Research Intstitute, Daejeon (KR)

(72) Inventors: Taesik Cheung, Daejeon (KR); Jeong-dong Ryoo, Daejeon (KR)

(21) Appl. No.: 14/351,319

(22) PCT Filed: Oct. 11, 2012
(86) PCT No.: PCT/KR2012/008279

§ 371 Date: Apr. 11, 2014

(30) Foreign Application Priority Data
Oct. 11, 2011 (KR) 10-2011-0103684
Oct. 11, 2012 (KR) 10-2012-0112811

(51) Int. Cl. H04L 12/24

(52) U.S. Cl. CPC H04L 41/0668
USPC 370/228

(57) ABSTRACT

A method of performing shared mesh protection switching in which congestion does not occur in a sharing segment and that quickly performs linear protection switching while using a 1-phase automatic protection switching protocol is provided. For protection switching of a working path that is included in a end-to-end linear protection domain having a high priority, because of congestion that may occur in a pre-emption process of stopping use of a shared protection segment of a working path that is included in a end-to-end linear protection domain having a low priority, a signal failure occurs at a protection path, and thus operation of a shared mesh protection switching protocol abnormally can be prevented.

### TECHNICAL FIELD

The present invention relates to a method of performing shared mesh protection switching that shares a protection path.

### BACKGROUND ART

Protection switching is a method of resuming traffic transmission when traffic transmission is stopped, when a signal failure occurs in a network. A protection switching method is classified into linear protection switching, ring protection switching, and mesh protection switching according to topology of a network.

Linear protection switching operates within a linear protection domain. That is, in a linear protection switching method, both endpoints that send and receive traffic and a working path and a protection path that connect the endpoints are defined as a linear protection domain, and by transmitting/receiving a message between endpoints according to a protocol, a protection switching function operates.

Mesh protection switching sets a linear protection domain for a point-to-point connection one by one and enables a protection path of a plurality of linear protection domains to share the same network resource, when a plurality of point-to-point connections is formed on a mesh topology network.

That is, mesh protection switching provides a mechanism in which a plurality of linear protection domains efficiently coordinates use of a network resource, when the plurality of linear protection domains having different endpoints exists in a mesh topology network.

An International Telecommunication Union-Telecommunication (ITU-T) standardization sector performs standardization of shared mesh protection switching to general shared mesh protection (G.smp) switching, and the International Engineering Task Force (IETF) is discussing shared mesh protection switching for Multi-Protocol Label Switching (hereinafter referred to as “MPLS”)-Transport Profile (TP).

A shared mesh protection switching method (PCT/KR2010/009295) provides the same protection switching time as that of conventional one-to-one linear protection switching. The shared mesh protection switching method includes a step of using a linear protection switching protocol between end nodes, but of requesting to stop use of a shared protection segment that is included in a protection path to an end node of the protection path that is included in an end-to-end linear protection domain having a lower priority. A shared path or a link may be included in a shared protection resource.

In this case, 1:1 linear protection switching that is used in a shared mesh protection switching method uses a 1-phase automatic protection switching (hereinafter referred to as “APS”) protocol that is used in a packet network such as Ethernet and MPLS and thus rapidly performs protection switching.

That is, an end node which detects a signal failure on a working path or receives a protection switching command from an operator first performs protection switching regardless of a response of a far-end node, transfers the fact to the far-end node using an APS message, and reports a protection switching event to a shared node. The shared node compares a priority of an end-to-end linear protection domain including a protection path corresponding to a working path in which a protection switching event is detected and a priority of an end-to-end linear protection domain including another protection path that shares a protection segment. As a priority comparison result, the shared node requests prohibition of protection switching to an end node that is connected to a protection path that is included in an end-to-end linear protection domain having the same or lower priority. Thereafter, the end node that receives the request performs the process of prohibiting protection switching by an APS protocol.

As described above, because an end node having detected a protection switching event reports the protection switching event and simultaneously switches traffic to the protection path, a congestion situation in which traffic exceeding a bandwidth of a shared protection segment is instantaneously injected to a shared protection segment of the protection path may occur.

Further, when congestion occurs at the shared protection segment, a continuity check (CC) message that is sent and received in order to monitor a state of a protection path between endpoints is lost and thus it may be determined that the protection path between endpoints is in a signal failure state. In this case, because a signal failure of a protection path generally has a higher priority than that of a working path, protection switching to the protection path is cancelled and thus a problem that a shared mesh protection switching mechanism erroneously operates may occur.

Because of the above problem, a 2-phase APS protocol may be used between end nodes. That is, after shared protection resource use of protection paths that are included in an end-to-end linear protection domain having a lower priority in each shared node on the protection path is stopped, a far-end node receives a protection switching message, performs protection switching, and receives a reply confirming that protection switching is performed from the far-end node, and an end node having detected a signal failure finally performs protection switching.

However, when using the above 2-phase APS protocol, there is a problem that the conventional linear protection switching mechanism should be modified, the protocol may be complicated, and the protection switching time increases further than that in a linear protection switching method using a conventional 1-phase APS protocol.

### DISCLOSURE

### Technical Problem

The present invention has been made in an effort to provide a method of performing shared mesh protection switching in which congestion does not occur in a sharing resource and that quickly performs linear protection switching while using a 1-phase automatic protection switching protocol.

### Technical Solution

An exemplary embodiment of the present invention provides a method of performing shared mesh protection switching in a shared node of a plurality of end-to-end linear protection domains each of which includes a working path and a protection path connecting two end nodes. The method includes: receiving a protection switching request from a first end node, having detected a signal failure (SF) of a working path that is included in a first end-to-end linear protection domain of the plurality of end-to-end linear protection domains to a first protection path that is included in the first end-to-end linear protection domain; determining whether a shared protection resource that the first protection path shares is available; and transmitting a protection switching reply to the first end node according to whether a shared protection resource is available.

The transmitting of a protection switching reply may include transmitting a protection switching available reply to the protection switching request to the first end node if the shared protection resource is not used.

The method may further include: receiving a protection switching completion message to the first protection path from the first end node, having received the protection switching available reply; and transmitting a resource unavailable message for the shared protection segment to each of a plurality of end nodes that are included in the remaining end-to-end linear protection domains, except for the first end-to-end linear protection domain of the plurality of end-to-end linear protection domains.

The transmitting of a protection switching reply may include: requesting, as a determination result on whether the shared protection segment is available, when the shared protection segment is being used by a second protection path included in a second end-to-end linear protection domain having a lower priority than that of the first end-to-end linear protection domain, to stop use of the shared protection segment to the second end node that is connected to the second protection path; receiving a use stop completion message of the shared protection segment from the second end node; and transmitting a protection switching available reply to the protection switching request to the first end node.

The method may further include: receiving a protection switching completion message to the first protection path from a first end node, having received the protection switching available reply; and transmitting a resource unavailable message for the shared protection segment to each of a plurality of end nodes that are included in the remaining end-to-end linear protection domains, except for the first end-to-end linear protection domain of the plurality of end-to-end linear protection domains.

The transmitting of a protection switching reply may include transmitting, as a determination result on whether the shared protection segment is available, a reply on whether protection switching is available to the first end node according to a priority determination rule of a predetermined end-to-end linear protection domain when the shared protection segment is available by a second protection path that is included in a second end-to-end linear protection domain having the same priority as that of the first end-to-end linear protection domain.

The priority determination rule may include a rule that is determined by a priority of an end node of the plurality of end-to-end linear protection domains or a priority of a protection path of the plurality of end-to-end linear protection domains.

Another embodiment of the present invention provides a method of performing shared mesh protection switching in a shared node of a plurality of end-to-end linear protection domains each of which includes a working path and a protection path connecting two end nodes. The method includes: receiving a protection switching request from a first end node that detects an SF of a first working path that has occurred in a first end-to-end linear protection domain of the plurality of end-to-end linear protection domains to a first protection path corresponding to the first working path; receiving a protection switching request from a second end node that detects an SF of a second working path that has occurred in a second end-to-end linear protection domain of the plurality of end-to-end linear protection domains to a second protection path corresponding to the second working path; comparing priorities of end-to-end linear protection domains including the first and second end nodes; and transmitting, if the first end-to-end linear protection domain has a higher priority than that of the second end-to-end linear protection domain, an available reply to a protection switching request to the first end node.

The method may further include transmitting an unavailable reply to the protection switching request to the second end node.

The method may further include: receiving a protection switching completion message to the first protection path from the first end node, having received the available reply; and transmitting a resource unavailable message to each of a plurality of end nodes that are included in the remaining at least one end-to-end linear protection domain, except for the first end-to-end linear protection domain.

Yet another embodiment of the present invention provides a method of performing shared mesh protection switching in an end node of an end-to-end linear protection domain which includes a working path and a protection path connecting two end nodes. The method includes: requesting, when an SF of the working path is detected, protection switching to the protection path to a plurality of shared nodes that are positioned on the protection path; completing, when a reply that the protection switching is available is received from the plurality of shared nodes, the protection switching; and notifying the plurality of shared nodes that the protection switching is complete.

The plurality of shared nodes may include all shared nodes that are positioned on the protection path.

The requesting of protection switching may include transmitting necessary information when the shared node determines a priority of an end-to-end linear protection domain including the protection path among the plurality of end-to-end linear protection domains.

The requesting of protection switching may include transmitting priority information of an end-to-end linear protection domain including the protection path and information including a kind of an SF that has occurred at the working path or ID of the end node.

The requesting of protection switching may include transmitting a message for requesting the protection switching to each of the plurality of shared nodes.

The requesting of protection switching may include transmitting a message for requesting protection switching to at least one shared node of the plurality of shared nodes, wherein the message may be transferred between the plurality of shared nodes.

### Advantageous Effects

According to an exemplary embodiment of the present invention, for protection switching of a working path that is included in an end-to-end linear protection domain having a high priority, because of congestion that may occur during preemption process of stopping the use of shared protection resource by a working path that is included in an end-to-end linear protection domain having a low priority, an SF occurs at a protection path, and thus abnormal operation of a shared mesh protection switching protocol can be fundamentally prevented.

Further, by separately defining a process of coordinating use of the shared protection resource and a process of actually performing protection switching, conventional 1-phase linear protection switching can be used.

### DESCRIPTION OF THE DRAWINGS

FIG. 1 is a diagram illustrating a sharing mesh protection domain according to an exemplary embodiment of the present invention.

FIG. 2 is a diagram illustrating a network in which a unidirectional SF has occurred in a working path according to an exemplary embodiment of the present invention.

FIG. 3 is a flowchart illustrating a shared mesh protection switching process when a unidirectional SF has occurred in a working path according to an exemplary embodiment of the present invention.

FIG. 4 is a diagram illustrating a network in which a unidirectional SF has occurred in a plurality of working paths according to an exemplary embodiment of the present invention.

FIG. 5 is a flowchart illustrating a shared mesh protection switching process when a unidirectional SF has occurred in a plurality of working paths according to an exemplary embodiment of the present invention.

FIG. 6 is a flowchart illustrating a shared mesh protection switching process when a resource of a protection path is available according to an exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, unless explicitly described to the contrary, the word “comprise” and variations such as “comprises” or “comprising” will be understood to imply the inclusion of stated elements but not the exclusion of any other elements.

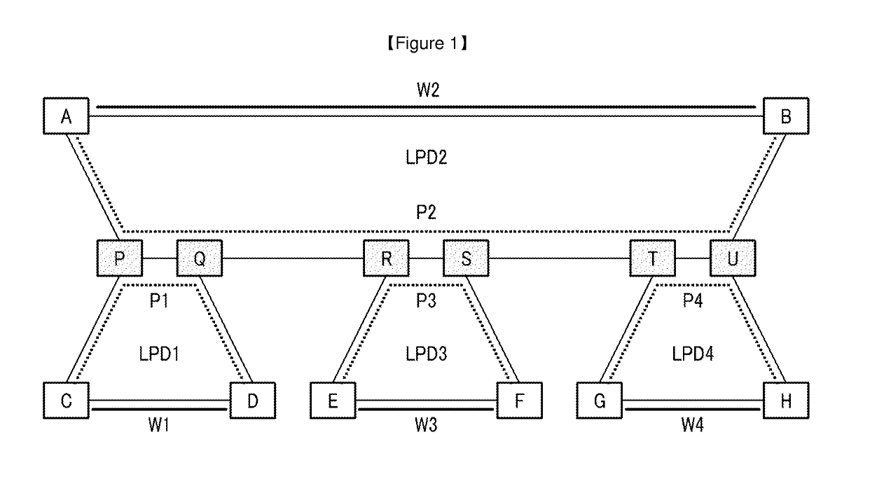

FIG. 1 is a diagram illustrating a sharing mesh protection domain according to an exemplary embodiment of the present invention.

Referring to FIG. 1, a sharing mesh protection domain includes a plurality of end node pairs and a plurality of shared nodes. A network may be various networks such as an Ethernet network, a provider backbone bridge-traffic engineering (PBB-TE) network, and an MPLS network.

An end-to-end linear protection domain includes a working path and a protection path, and the working path and the protection path connect an end node pair. A plurality of protection paths each of which is included in an end-to-end linear protection domain shares a resource (bandwidth) between shared nodes.

Referring to FIG. 1, an end node C and an end node D are connected by a working path W1 and a protection path P1. The protection path P1 shares a sharing path P-Q. An end-to-end linear protection domain 1 (hereinafter referred to as an “LPD1”) includes the working path W1 and the protection path P1.

An end node A and an end node B are connected by a working path W2 and a protection path P2. The protection path P2 shares sharing paths P-Q, R-S, and T-U. An end-to-end linear protection domain 2 (hereinafter referred to as an “LPD2”) includes a working path W2 and a protection path P2.

An end node E and an end node F are connected by a working path W3 and a protection path P3. The protection path P3 shares a sharing path R-S. An end-to-end linear protection domain 3 (hereinafter referred to as an “LPD3”) includes a working path W3 and a protection path P3.

An end node G and an end node H are connected by a working path W4 and a protection path P4. The protection path P4 shares a sharing path T-U. An end-to-end linear protection domain 4 (hereinafter referred to as an “LPD4”) includes a working path W1 and a protection path P4.

That is, the protection paths P1 and P2 share the sharing path P-Q, the protection paths P2 and P3 share the sharing path R-S, and the protection paths P2 and P4 share the sharing path T-U.

In an exemplary embodiment of the present invention, it is assumed that a priority of each linear protection domain is LPD1>LPD2>LPD3>LPD4. It is assumed that in each end node pair (A and B, C and D, E and F, and G and H), a 1:1 linear protection switching protocol operates, and each end node pair operates by a bi-directional protection switching method.

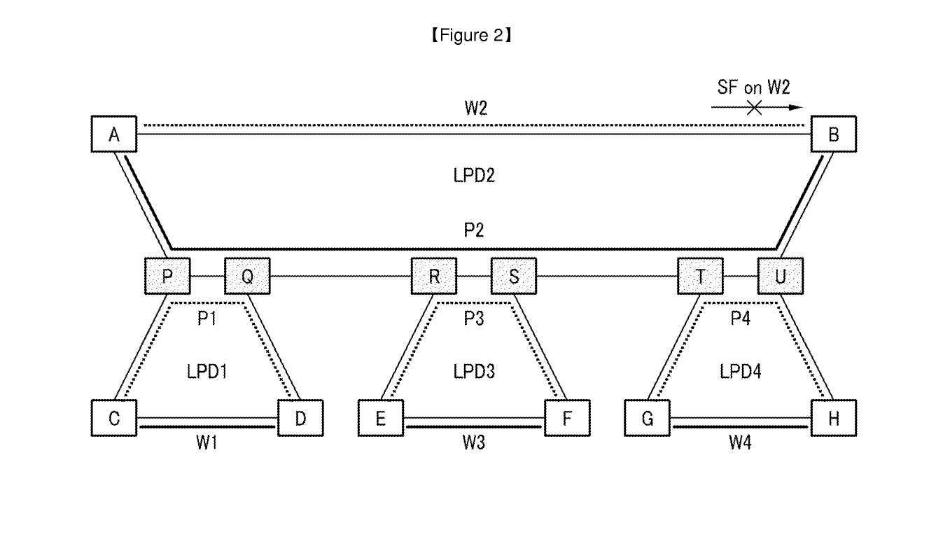

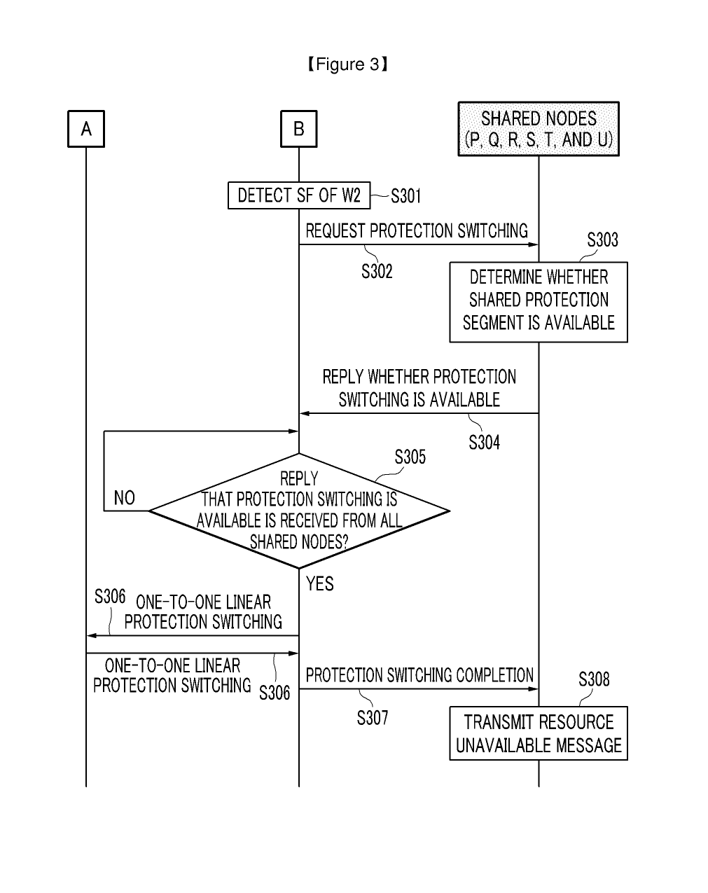

FIG. 2 is a diagram illustrating a network in which a unidirectional SF has occurred in a working path according to an exemplary embodiment of the present invention, and FIG. 3 is a flowchart illustrating a shared mesh protection switching process according to an exemplary embodiment of the present invention.

Referring to FIGS. 2 and 3, the end node B detects an SF of the working path W2 (S301), and for protection switching to a protection path, the end node B requests protection switching to all shared nodes U, T, S, R, Q, and P on the protection path P2 (S302).

In this case, a message that requests protection switching may include priority information of an end-to-end linear protection domain including a corresponding protection path, a type of failure that has occurred in a working path, and node ID as information necessary for identifying the priority of the end-to-end linear protection domain including the corresponding protection path by a shared node.

Further, the end node B uses a method of requesting to each shared node with a one-to-one method using a plurality of messages on a shared node basis. Alternatively, the end node B may use a method (drop and forward) of transferring a request via each shared node using one message.

In an exemplary embodiment of the present invention, because a message transfer path for protection switching is previously secured through a protection path between endpoints, by using a method (drop and forward) of transferring a request via each shared node using one message, protection switching is rapidly performed.

In this case, when end node pairs do not operate by a bi-directional protection switching method but operate by a unidirectional protection switching method, for protection switching, protection switching may not be requested to all shared nodes on the protection path.

That is, an end node that detects an SF of the working path may request protection switching to only one shared node of shared nodes of a shared protection resource of the protection path. In an exemplary embodiment of the present invention, when operation is performed with an unidirectional protection switching method, an SF has occurred at a working path from an end node A to B, and thus a protection path to shared nodes P→Q→R→S→T→U should be used. In this case, the end node B that detects an SF of the working path W2 may request protection switching to only Q, S, and U among shared nodes of shared protection paths P-Q, R-S, and T-U. Thereafter, the shared nodes U, T, S, R, Q, and P, having received a protection switching request from the end node B determine whether a shared protection resource including the shared nodes U, T, S, R, Q, and P is available (S303) and reply whether protection switching is available (S304).

In this case, when a protection path that is included in an end-to-end linear protection domain of a lower priority than a protection path in which protection switching is requested is already using a shared protection resource, protection switching is available. In this case, the shared node requests to stop use of a shared protection resource to an end node that is connected to a protection path that is included in an end-to-end linear protection domain having a lower priority. Thereafter, the shared node receives a report of use stop of a shared protection resource from a corresponding end node, and notifies an end node requesting protection switching that protection switching is available.

When a protection path that is included in an end-to-end linear protection domain having a higher priority than a protection path in which protection switching is requested is already using a shared protection resource, protection switching is unavailable and thus the shared node notifies an end node requesting protection switching that protection switching is unavailable.

When a protection path that is included in an end-to-end linear protection domain having the same priority as that of a protection path in which protection switching is requested is already using a shared protection resource, a possibility of protection switching may be determined according to a priority determination rule (e.g., a rule according to a priority between end nodes that are included in a plurality of end-to-end linear protection domains or a priority of a protection path that is included in a plurality of end-to-end linear protection domains) that is randomly allocated to each shared node of the protection path.

In an exemplary embodiment of the present invention, when the shared nodes U, T, S, R, Q, and P receive a protection switching request from the end node B, the protection path P1 does not use the shared protection path P-Q, the protection path P3 does not use the shared protection path R-S, and the protection path P4 does not use the shared protection path T-U. Therefore, the shared nodes U, T, S, R, Q, and P notify the end node B that protection switching to the protection path P2 is available.

Thereafter, the end node determines whether a reply that protection switching is available is received from all shared nodes requesting protection switching (S305). In an exemplary embodiment of the present invention, because the end node B received a reply that protection switching is available from all shared nodes U, T, S, R, Q, and P on the protection path P2, the end nodes A and B complete protection switching according to 1:1 linear protection switching (S306).

The end node B transmits a protection switching completion message to all shared nodes U, T, S, R, Q, and P on the protection path P2 (S307), thereby notifying that protection switching is complete.

The shared nodes U, T, S, R, Q, and P, having received a completion message of protection switching calculate an available resource of a shared protection resource and transmit a resource unavailable message to an end node of a protection path in which protection switching is unavailable in consideration of a priority of end-to-end linear protection domains including a protection path (S308).

In an exemplary embodiment of the present invention, the shared nodes U, T, S, and R each transmit a resource unavailable message to the end nodes H, G, F, and E that are connected to protection paths P3 and P4 that are included in an end-to-end linear protection domain having a lower priority than that of the protection path P2. However, because the protection path P1 is higher in priority of an end-to-end linear domain than the protection path P2, the shared nodes Q and P do not transmit a resource unavailable message to the end nodes D and C.

The end nodes E, F, G, and H, having received a resource unavailable message from the shared node prohibits protection switching according to the 1:1 linear protection switching method. Therefore, even if an SF occurs in the working path W3 or W4, the end nodes E, F, G, and H cannot perform protection switching to the protection path P3 or P4. That is, even if an SF occurs in the working path W4 and the end node H detects an SF of the working path W4, the end node H having received a resource unavailable message does not request protection switching to the shared nodes U and T.

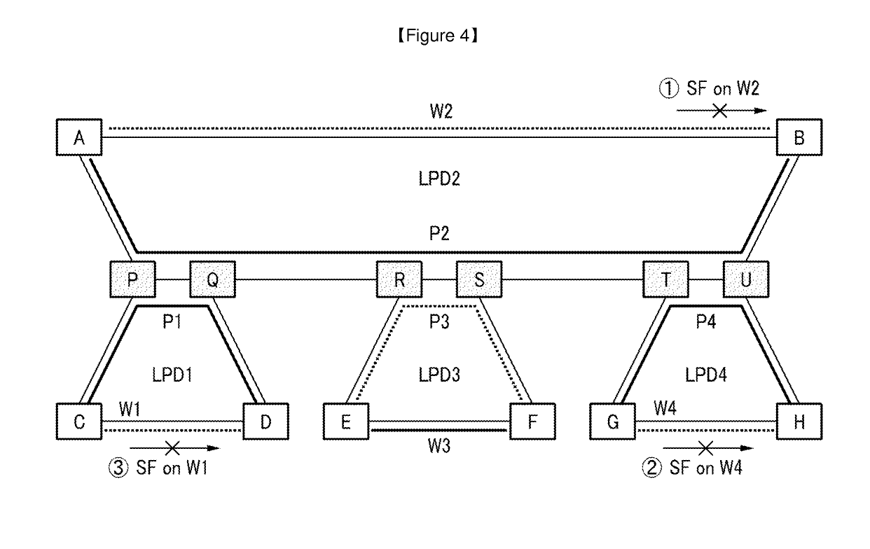

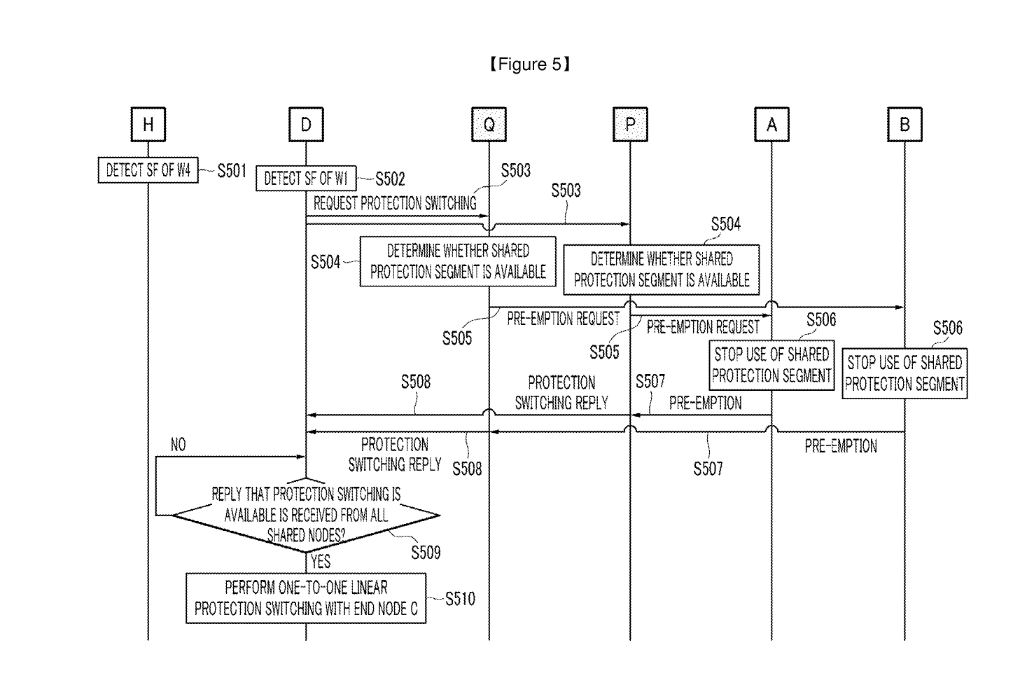

FIG. 4 is a diagram illustrating a network in which a unidirectional SF has occurred in a plurality of working paths according to an exemplary embodiment of the present invention, and FIG. 5 is a flowchart illustrating a shared mesh protection switching process when a unidirectional SF has occurred in a plurality of working paths according to an exemplary embodiment of the present invention.

In an exemplary embodiment of the present invention, an SF of the working path W2 according to FIGS. 2 and 3 first occurs, then an SF occurs in the working path W4 according to FIGS. 4 and 5, and an SF finally occurs in the working path W1.

Referring to FIG. 4, as an SF first occurs in the working path W2, the end nodes A and B use the protection path P2, and thereafter, as an SF occurs in the working path W4, when the end node H detects an SF (S501), the end node H having received a resource unavailable message does not request protection switching to the shared nodes U and T.

Thereafter, the end node D detects an SF of the working path W1 (S502). The end node D that does not receive a resource unavailable message from the shared nodes U, T, S, and R requests protection switching to both shared nodes P and Q on the protection path P1 for protection switching to a protection path (S503).

The shared nodes P and Q having received a protection switching request message from the end node D determine whether a shared protection resource that is connected to them is available (S504). In an exemplary embodiment of the present invention, because the shared protection path P-Q is being used by the protection path P2, a shared protection resource is unavailable.

Thereafter, because the protection path P2 is lower in priority of an end-to-end linear protection domain than the protection path P1, the shared nodes P and Q each transmit a pre-emption request message for a shared protection resource to the end nodes A and B (S505).

That is, a pre-emption request in which the shared node transmits is a message in which a shared node having received a protection switching request message from an end node attempting to use a protection path determines a priority of an end-to-end linear protection domain including a protection path and that requests to stop use of a shared protection resource to an end node that is already using a shared protection resource.

The end nodes A and B having received the pre-emption request from the shared nodes P and Q stop use of the protection path P2 by performing protection switching prohibition according to a 1:1 linear protection switching method (S506), and reply to the shared nodes P and Q that pre-emption is complete (S507).

The shared nodes P and Q having received the pre-emption reply from the end nodes A and B reply to the end node D that protection switching to the protection path P1 is available (S508).

Thereafter, the end node D determines whether a reply that protection switching is available is received from both shared nodes P and Q on the protection path P1 (S509), and if a reply that protection switching is available is received from both shared nodes P and Q, the end node D performs protection switching with the end node C according to a 1:1 linear protection switching method (S510). The following process is the same as the protection switching completion step (S307) and the resource unavailable message transmission step (S308) that are described in FIGS. 2 and 3.

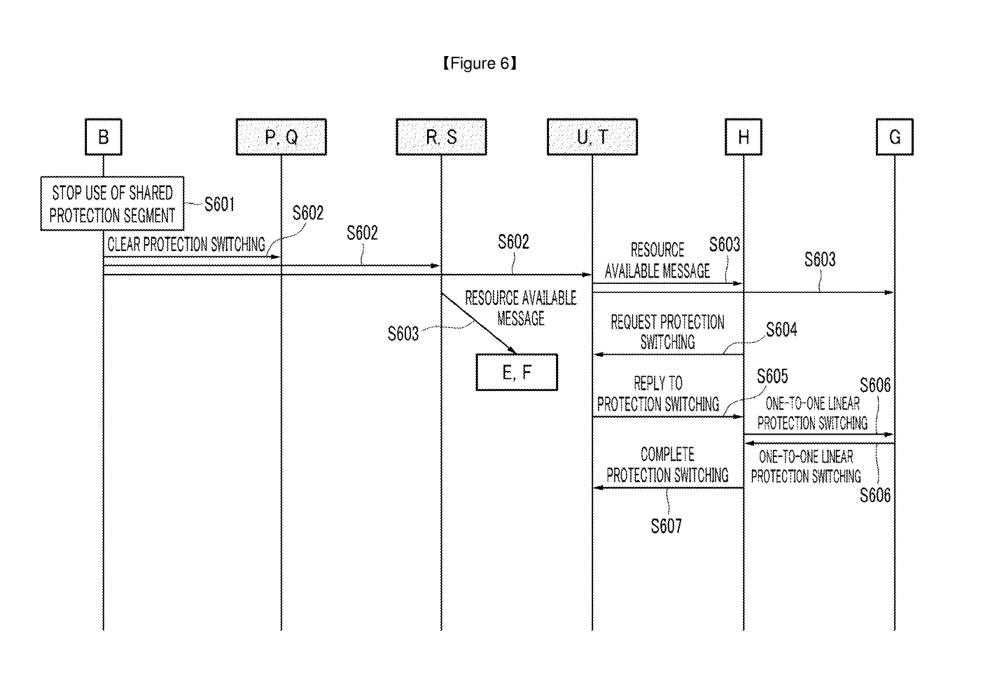

FIG. 6 is a flowchart illustrating a shared mesh protection switching process when a resource of a protection path is available according to an exemplary embodiment of the present invention.

Referring to FIG. 6, the end node B stops use of the shared protection path P-Q (S601), and thus the end node B that stops protection switching to the protection path P2 notifies all shared nodes U, T, S, R, Q, and P on the protection path P2 that protection switching is cleared (S602).

That is, a protection switching clear event is a message notifying that as protection switching to the protection path is cleared, an end node that transmits the protection switching clear event again uses a working path and each shared node on the protection path can use a shared protection resource.

In this case, the shared node having received the protection switching clear event again calculates availability of a shared protection resource and transmits a resource available message to an end node of a protection path in which protection switching is available through the remaining shared protection resource (S603).

In an exemplary embodiment of the present invention, the shared nodes U, T, S, and R, having received the protection switching clear event from the end node B transmit resource available messages to the end nodes H, G, F, and E, respectively.

Thereafter, as the end node H having detected an SF of the working path W4 receives a resource available message, the end node H recognizes that the protection path P4 is available and requests protection switching to both shared nodes U and T on the protection path P4 (S604).

The shared nodes U and T having received a protection switching request message of the end node H determine whether a shared protection resource that is connected thereto is available. In an exemplary embodiment of the present invention, due to protection switching clear of the protection path P2, because the shared protection path T-U is available, the shared nodes U and T reply to the end node H that protection switching is available (S605).

Thereafter, the end node H having received a reply that protection switching is available from both shared nodes U and T on the protection path P4 completes protection switching with the end node G according to 1:1 linear protection switching (S606), and notifies that protection switching is complete to both shared nodes U and T on the protection path P4 (S607).

In this case, because an end-to-end linear protection domain having a lower priority than an LPD4 that is connected to the shared nodes U and T does not exist, the shared nodes U and T, having received a protection switching completion event, do not transmit a resource unavailable message to any shared node.

As described above, according to an exemplary embodiment of the present invention, for protection switching of a working path that is included in an end-to-end linear protection domain having a high priority, because of congestion that may occur during pre-emption process that stops use of a shared protection resource of a working path that is included in an end-to-end linear protection domain having a lower priority, an SF occurs in a working path and thus it can be fundamentally prevented that a shared mesh protection switching protocol abnormally operates.

Further, by separately defining a process of coordinating use of a shared protection resource and a process of actually performing protection switching, conventional 1-phase linear protection switching can be used.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of performing shared mesh protection switching in a shared node of a plurality of end-to-end linear protection domains comprising a working path and a protection path connecting two end nodes, the method comprising:
receiving a protection switching request from a first end node, having detected a signal failure (SF) of a working path that is included in a first end-to-end linear protection domain of the plurality of end-to-end linear protection domains to a first protection path that is included in the first end-to-end linear protection domain;
determining whether a shared protection resource that the first protection path shares is available; and
transmitting a protection switching reply to the first end node according to whether a shared protection resource is available.

2. The method of claim 1, wherein the transmitting of a protection switching reply comprises transmitting, if a shared protection segment is unavailable, a protection switching available reply to the protection switching request to the first end node.

3. The method of claim 2, further comprising:
receiving a protection switching completion message to the first protection path from the first end node, having received the protection switching available reply; and
transmitting a resource unavailable message for a shared protection segment to each of a plurality of end nodes that are included in the remaining end-to-end linear protection domain, except for the first end-to-end linear protection domain of the plurality of end-to-end linear protection domains.

4. The method of claim 1, wherein the transmitting of a protection switching reply comprises:
requesting, as a determination result on whether the shared protection segment is available, when the shared protection segment is being used by a second protection path included in a second end-to-end linear protection domain having a lower priority than that of the end-to-end first linear protection domain, to stop use of the shared protection segment to a second end node that is connected to the second protection path;
receiving a use stop completion message of the shared protection segment from the second end node; and
transmitting a protection switching available reply to the protection switching to the first end node.

5. The method of claim 4, further comprising:
receiving a protection switching completion message to the first protection path from a first end node, having received the protection switching available reply; and
transmitting a resource unavailable message for a shared protection segment to each of a plurality of end nodes that are included in the remaining end-to-end linear protection domain, except for the first end-to-end linear protection domain of the plurality of end-to-end linear protection domains.

6. The method of claim 1, wherein the transmitting of a protection switching reply comprises transmitting, as a determination result on whether the shared protection segment is available, a reply on whether protection switching is available to the first end node according to a predetermined priority determination rule of a end-to-end linear protection domain when the shared protection segment is available by a second protection path that is included in a second end-to-end linear protection domain having the same priority as that of the first end-to-end linear protection domain.

7. The method of claim 6, wherein the priority determination rule comprises a rule that is determined by a priority of an end node of the plurality of end-to-end linear protection domains or a priority of a protection path of the plurality of end-to-end linear protection domains.

8. A method of performing shared mesh protection switching in a shared node of a plurality of end-to-end linear protection domains comprising a working path and a protection path connecting two end nodes, the method comprising:
receiving a protection switching request from a first end node that detects an SF of a first working path that has occurred in a first end-to-end linear protection domain of the plurality of end-to-end linear protection domains to a first protection path corresponding to the first working path;
receiving a protection switching request from a second end node that detects an SF of a second working path that has occurred in a second end-to-end linear protection domain of the plurality of end-to-end linear protection domains to a second protection path corresponding to the second working path;
comparing priorities of end-to-end linear protection domains comprising the first and second end nodes; and
transmitting, if the first end-to-end linear protection domain has a higher priority than that of the second end-to-end linear protection domain, an available reply to the protection switching request to the first end node.

9. The method of claim 8, further comprising transmitting an unavailable reply to the protection switching request to the second end node.

10. The method of claim 8, further comprising:
receiving a protection switching completion message to the first protection path from the first end node, having received the available reply; and
transmitting a resource unavailable message to each of a plurality of end nodes that are included in the remaining at least one end-to-end linear protection domain, except for the first end-to-end linear protection domain.

11. A method of performing shared mesh protection switching in an end node of a end-to-end linear protection domain comprising a working path and a protection path connecting the end node with another end node, the method comprising:
requesting, when an SF of the working path is detected, protection switching to the protection path to a plurality of shared nodes that are positioned on the protection path;
completing, when a reply that the protection switching is available is received from the plurality of shared nodes, the protection switching; and
notifying the plurality of shared nodes that the protection switching is complete.

12. The method of claim 11, wherein the plurality of shared nodes comprise all shared nodes that are positioned on the protection path.

13. The method of claim 11, wherein the requesting of protection switching comprises transmitting necessary information when the shared node determines a priority of a end-to-end linear protection domain comprising the protection path among the plurality of end-to-end linear protection domains.

14. The method of claim 11, wherein the requesting of protection switching comprises transmitting priority information of a end-to-end linear protection domain comprising the protection path and information comprising a kind of an SF that has occurred at the working path or ID of the end node.

15. The method of claim 11, wherein the requesting of protection switching comprises transmitting a message for requesting the protection switching to each of the plurality of shared nodes.

16. The method of claim 11, wherein the requesting of protection switching comprises transmitting a message for requesting protection switching to at least one shared node of the plurality of shared nodes,
wherein the message is transferred between the plurality of shared nodes.
